(19) United States
(12) Patent Application Publication
(10) Pub. No.: US 2019/0311014 A1
(43) Pub. Date: Oct. 10, 2019

(54) INFORMATION PRESENTATION DEVICE, INFORMATION PRESENTATION SYSTEM, AND INFORMATION PRESENTATION METHOD

(71) Applicant: Mitsubishi Electric Corporation, Tokyo (JP)

(72) Inventor: Hisashi SUGAWARA, Tokyo (JP)

(73) Assignee: Mitsubishi Electric Corporation, Tokyo (JP)

(21) Appl. No.: 16/315,094

(22) PCT Filed: Aug. 22, 2016
(86) PCT No.: PCT/JP2016/074358

§ 371 Date: Jan. 3, 2019

(51) Int. Cl. G06F 16/9535; G06F 16/9537; G06F 16/9538; G01C 21/36

(52) U.S. Cl. CPC G06F 16/9535; G01C 21/36; G06F 16/9538; G06F 16/9537

(57) ABSTRACT

There are included an action pattern identifying unit for identifying, on the basis of at least occupant composition of a host vehicle and time information, an action pattern of an occupant of the host vehicle from information indicating action patterns estimated from past travel histories of the host vehicle; a history data extracting unit for extracting movement histories in which other vehicles pass through a preset reference point and travel histories in which the host vehicle passes through the reference point, among movement histories of the other vehicles and travel histories of the host vehicle related to the identified action pattern; a recommended point obtaining unit for obtaining a first recommended point on the basis of probabilities of transition for the extracted movement histories, and obtaining a second recommended point on the basis of probabilities of transition for the extracted travel histories; and a recommended destination determining unit for determining a first recommended destination and a second recommended destination to be presented to the occupant of the host vehicle, from the first recommended point and the second recommended point.

### TECHNICAL FIELD

The invention relates to a technique for presenting information that can serve as candidates for a destination.

### BACKGROUND ART

Conventionally, there is a technique for presenting a user of a device with other destinations visited by other users having visited the same destination as the user, as recommended destinations, on the basis of information on action histories collected from a plurality of users.

For example, in a navigation system disclosed in Patent Literature 1, an action pattern that matches an action tendency of a target user is determined and correlation levels between points which are grasped on the basis of movement history data related to the determined action pattern are calculated, by which recommendation of candidates for a destination which reflect also the action tendency of the target user is performed.

### CITATION LIST

### Patent Literatures

Patent Literature 1: JP 2014-199212 A

### SUMMARY OF INVENTION

### Technical Problem

However, candidates for a destination which are obtained by the technique described in the above-described Patent Literature 1 and which reflect the correlation levels between points have a problem. The problem is that an action mode of the target user may not be able to be reflected. For example, when there are a restaurant X and an eating place Y that have a high correlation level between points, presenting the eating place Y after eating at the restaurant X is not useful information. In addition, in the technique described in Patent Literature 1, in both of a case in which the target user is traveling within his/her living area and a case in which the target user is traveling outside his/her living area, the same action tendency of the target user is applied. Thus, there is a problem in which candidates for a destination which flexibly reflect an action tendency of the user which occurs when the target user is, e.g., on his/her trip cannot be recommend.

The invention is made to solve problems such as that described above, and an object of the invention is to present information in which a demand of an occupant of a host vehicle is flexibly reflected.

### Solution to Problem

An information presentation device according to the present invention includes: an action pattern identifying unit for identifying, on the basis of at least occupant composition of a host vehicle and time information, an action pattern of an occupant of the host vehicle from information indicating action patterns estimated from past travel histories of the host vehicle; a history data extracting unit for extracting movement histories in which other vehicles pass through a preset reference point and travel histories in which the host vehicle passes through the reference point, among movement histories of the other vehicles and travel histories of the host vehicle related to the action pattern identified by the action pattern identifying unit; a recommended point obtaining unit for obtaining a first recommended point on the basis of probabilities of transition indicating probabilities of going to respective points from the reference point in the movement histories extracted by the history data extracting unit, and obtaining a second recommended point on the basis of probabilities of transition indicating probabilities of going to respective points from the reference point in the travel histories extracted; and a recommended destination determining unit for determining a first recommended destination and a second recommended destination to be presented to the occupant of the host vehicle, from the first recommended point and the second recommended point obtained by the recommended point obtaining unit.

### Advantageous Effects of Invention

According to the invention, information in which a demand of an occupant of a host vehicle is flexibly reflected can be presented.

### BRIEF DESCRIPTION OF DRAWINGS

FIG. 1 is a block diagram showing a configuration of an information presentation device according to a first embodiment.

FIG. 2 is a diagram showing examples of life patterns accumulated in a life pattern accumulating unit of the information presentation device according to the first embodiment.

FIG. 3 is a diagram showing examples of action patterns accumulated in an action pattern accumulating unit of the information presentation device according to the first embodiment.

FIGS. 4A and 4B are diagrams showing exemplary hardware configurations of the information presentation device according to the first embodiment.

FIG. 5 is a flowchart showing the operation of the information presentation device according to the first embodiment.

FIG. 6A is a diagram showing examples of movement histories extracted by a history data extracting unit of the information presentation device according to the first embodiment, and FIG. 6B is a diagram showing examples of travel histories extracted by the history data extracting unit.

FIG. 7 is a diagram showing exemplary display resulting from display control performed by a recommended destination determining unit of the information presentation device according to the first embodiment.

FIG. 8 is a block diagram showing a configuration of an information presentation device according to a second embodiment.

FIG. 9 is a diagram showing examples of action patterns accumulated in an action pattern accumulating unit of the information presentation device according to the second embodiment.

FIG. 10 is a block diagram showing a configuration of a display control device according to a third embodiment.

FIG. 11 is a flowchart showing the operation of the display control device according to the third embodiment.

FIG. 12 is a diagram showing an overview of an information presentation system according to a fourth embodiment.

FIG. 13 is a block diagram showing a configuration of the information presentation system according to the fourth embodiment.

FIGS. 14A and 14B are diagrams showing exemplary hardware configurations of an information presentation device according to the fourth embodiment.

FIG. 15 is a flowchart showing the operation of the server device in the information presentation system according to the fourth embodiment.

FIG. 16 is a sequence diagram showing the operation of the information presentation system according to the fourth embodiment.

### DESCRIPTION OF EMBODIMENTS

To describe the invention in more detail, modes for carrying out the invention will be described below with reference to the accompanying drawings.

### First Embodiment

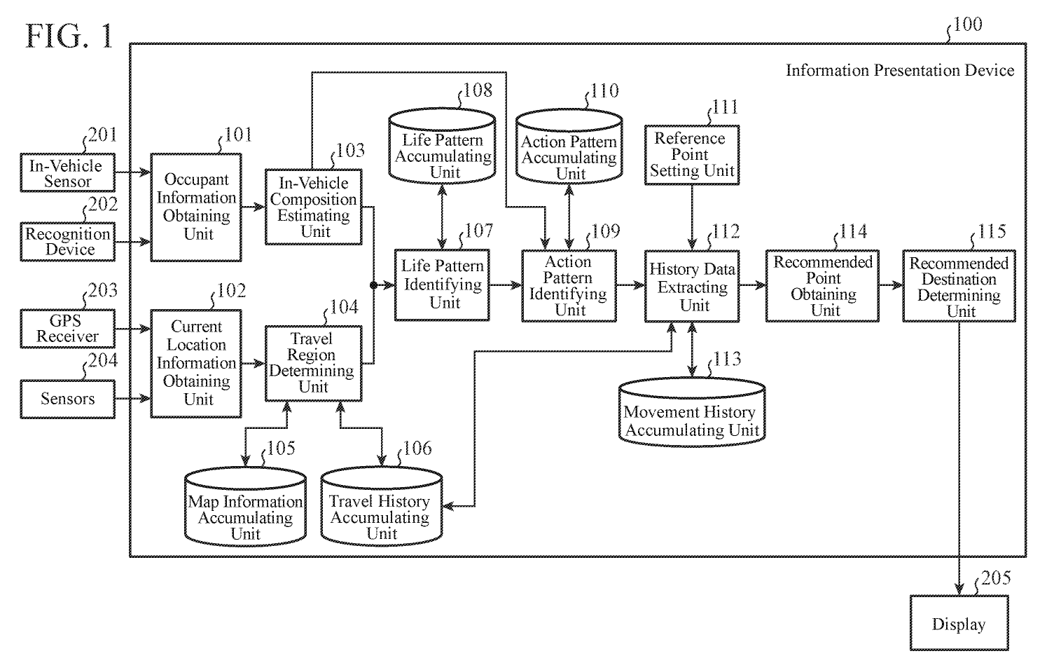

FIG. 1 is a block diagram showing a configuration of an information presentation device according to a first embodiment.

An information presentation device 100 includes an occupant information obtaining unit 101, a current location information obtaining unit 102, an in-vehicle composition estimating unit 103, a travel region determining unit 104, a map information accumulating unit 105, a travel history accumulating unit 106, a life pattern identifying unit 107, a life pattern accumulating unit 108, an action pattern identifying unit 109, an action pattern accumulating unit 110, a reference point setting unit 111, a history data extracting unit 112, a movement history accumulating unit 113, a recommended point obtaining unit 114, and a recommended destination determining unit 115.

In addition, FIG. 1 shows an example case in which the information presentation device 100 is connected to external devices including an in-vehicle sensor 201, a recognition device 202, a global positioning system (GPS) receiver 203, sensors 204, and a display 205. It is assumed that these external devices are mounted on a host vehicle. In addition, the external devices are not limited to the above-described configuration, that is, another external device may be appropriately added as necessary or one of the external devices may be appropriately eliminated as necessary.

The in-vehicle sensor 201 is composed of, for example, an imaging sensor, etc., and obtains information for identifying occupant of the host vehicle. The recognition device 202 performs recognition using the face, fingerprints, etc., of the occupant of the vehicle, recognition by ID check, or the like, and thereby identifies the occupant. The recognition device 202 outputs information for identifying the occupant. The GPS receiver 203 obtains location information indicating a location of the host vehicle from received GPS signals. The sensors 204 are sensors mounted on the host vehicle, and obtain orientation information indicating a traveling direction of the host vehicle, distance information indicating a distance traveled by the host vehicle, and the like. The display 205 displays information presented from the information presentation device 100.

The occupant information obtaining unit 101 obtains occupant information from a captured image, a result of detection, or the like, obtained by the in-vehicle sensor 201. The occupant information is, for example, information indicating whether there is a passenger, the number of occupants, and an attribute such as gender of the occupant and age of the occupant. In addition, the occupant information obtaining unit 101 may obtain, as occupant information, information for identifying each occupant which is obtained by the recognition device 202 performing recognition of each occupant. Furthermore, the occupant information obtaining unit 101 may obtain, as occupant information, pre-recorded user information which is obtained by the recognition device 202 checking ID which is issued in advance upon user registration.

The current location information obtaining unit 102 obtains current location information indicating a current location of the host vehicle from the location information of the host vehicle received by the GPS receiver 203, the orientation information of the host vehicle and the distance information of the host vehicle obtained by the various types of sensors 204, etc.

The in-vehicle composition estimating unit 103 estimates occupant composition in the vehicle on the basis of the occupant information obtained by the occupant information obtaining unit 101. The in-vehicle composition estimating unit 103 estimates, as the occupant composition in the vehicle, for example, an attribute of the occupant such as the number of occupants, gender of the occupant, an age group of the occupant, whether a married couple or an unmarried couple is on the vehicle, and whether a family is on the vehicle.

The travel region determining unit 104 determines whether the host vehicle is traveling within or outside a living area, on the basis of the current location information obtained by the current location information obtaining unit 102 and map information stored in the map information accumulating unit 105. Here, the living area is, for example, a region in a range within a preset distance from a point at which daily activities are performed, such as a region in a range within a ten-kilometer radius of a home or a region in a range within a five-kilometer radius of a work place. Note, however, that when the travel region determining unit 104 determines, by referring to information indicating travel histories of the host vehicle and accumulated in the travel history accumulating unit 106, that the host vehicle is traveling a region where the host vehicle has never traveled before, the travel region determining unit 104 may determine that the host vehicle is traveling outside the living area, even if the host vehicle is traveling the region in the range within the preset distance.

The map information accumulating unit 105 accumulates map data, facility data, etc., as map information. The map data is data representing a road network including a plurality of nodes and a plurality of links each corresponding to a road connecting two nodes, coordinate information indicating the locations of specific points, attribute information indicating the names, genres, and the like, of the specific points, etc. The facility data is coordinate information indicating the locations of respective facilities, attribute information indicating the names, genres, etc., of the respective facilities, etc. It is assumed that information on living areas of drivers of the host vehicle is set in advance in the map data accumulated in the map information accumulating unit 105.

The travel history accumulating unit 106 accumulates routes that the host vehicle has traveled in the past, as travel histories. The travel history accumulating unit 106 may accumulate, as travel histories, information on points or facilities where occupants of the host vehicle have visited in the past, the number of times that occupants of the host vehicle have visited the points or facilities, etc.

The life pattern identifying unit 107 identifies a life pattern of the occupant of the host vehicle from life patterns accumulated in the life pattern accumulating unit 108, on the basis of the occupant composition in the vehicle estimated by the in-vehicle composition estimating unit 103, a result of the determination obtained by the travel region determining unit 104, a travel point of the host vehicle, and time information indicating current time. Specifically, the life pattern identifying unit 107 identifies whether the occupant is acting in a daily life pattern or a non-daily life pattern. The life pattern identifying unit 107 more specifically identifies, as the daily life pattern of the occupant of the host vehicle, for example, commuting of an office worker, housewife's movement by the vehicle, going out on a weekend, etc. The life pattern identifying unit 107 more specifically identifies, as the non-daily life pattern of the occupant of the host vehicle, for example, a business trip of an office worker, an outing, etc.

The life pattern accumulating unit 108 accumulates information indicating the life patterns of occupants of the host vehicle.

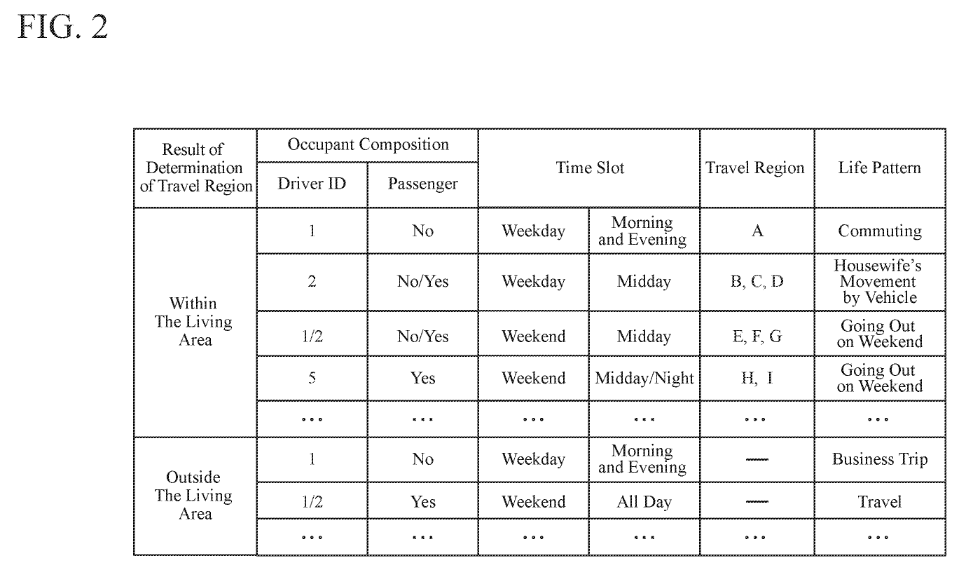

Examples of life patterns accumulated in the life pattern accumulating unit 108 are shown in FIG. 2. The life patterns accumulated in the life pattern accumulating unit 108 are associated with items, e.g., a result of determination of a travel region, occupant composition, a time slot, and a travel region. The life pattern identifying unit 107 identifies the life pattern of the occupant of the host vehicle, by identifying that a life pattern having matching or similar items is a life pattern of the host vehicle while referring to the items associated with each of the life patterns.

The action pattern identifying unit 109 identifies a current action pattern of the occupant of the host vehicle from the past action patterns of occupants accumulated in the action pattern accumulating unit 110, on the basis of the life pattern identified by the life pattern identifying unit 107, the occupant composition in the vehicle estimated by the in-vehicle composition estimating unit 103, and time information indicating current time.

Note that when the action pattern identifying unit 109 does not need to refer to life-pattern-based classification upon identifying an action pattern, the action pattern identifying unit 109 does not necessarily need to operate on the basis of the life pattern.

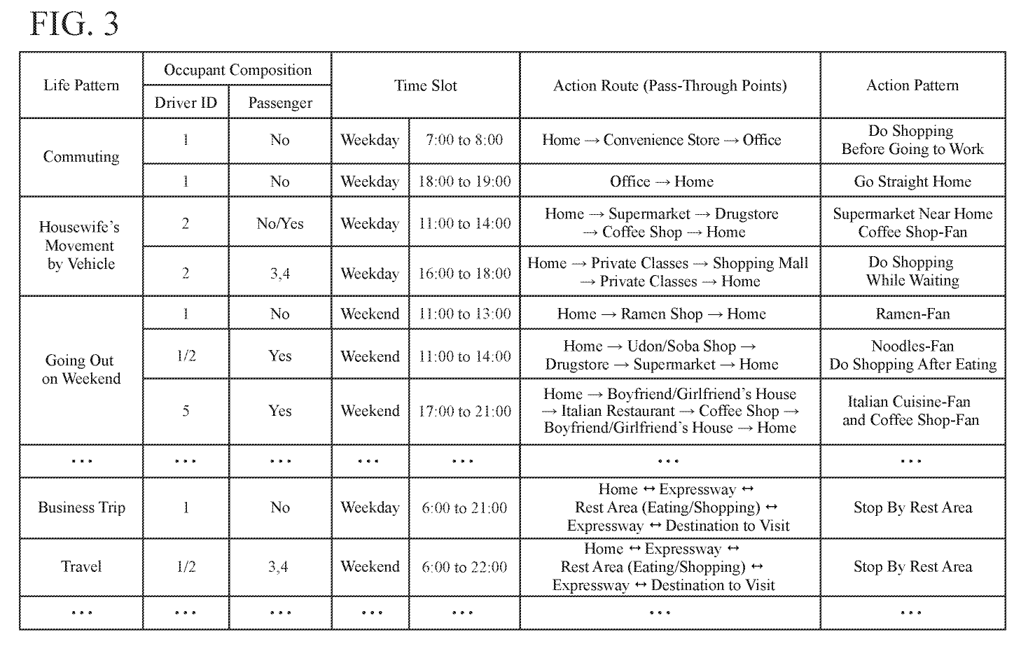

The action pattern accumulating unit 110 accumulates information indicating the past action patterns of occupants estimated from the past travel histories of the host vehicle. Examples of action patterns accumulated in the action pattern accumulating unit 110 are shown in FIG. 3. The action patterns accumulated in the action pattern accumulating unit 110 are associated with items, e.g., a life pattern, occupant composition, a time slot, and an action route (pass-through points).

In the item “life pattern”, a life pattern to be identified by the life pattern identifying unit 107 is described.

In the item “occupant composition”, for example, information indicating whether only one occupant is on the vehicle, whether two people including an occupant and his/her girlfriend/boyfriend are on the vehicle, or whether four family members are on the vehicle is described. In the item “occupant composition”, information by which occupants are identified may be presented by describing an ID of each occupant, or such a level of information that allows to grasp the number of occupants and a relationship between occupants may be presented. In addition, in the item “occupant composition”, ages or genders of occupants may be presented.

In the item “time slot”, for example, information indicating whether it is a weekday or a weekend and information indicating an approximate period of time from a departure to a return to home are described.

In the item “action route”, for example, information is described that indicates the attributes of points or facilities through which the host vehicle passes before arriving at a destination or returning to home after departing home.

In the item “action pattern”, an action pattern of occupants is described.

The reference point setting unit 111 sets a reference point serving as a reference point upon calculating recommended destinations. The reference point setting unit 111 sets, for example, a current location of the host vehicle as a reference point, on the basis of the current location information obtained by the current location information obtaining unit 102. Alternatively, the reference point setting unit 111 may set, as a reference point, a destination that is already set on a navigation device (not shown) mounted on the host vehicle. In this case, the information presentation device 100 calculates recommended destinations using, as a departure point, the destination which is already set on the navigation device.

The history data extracting unit 112 obtains movement histories that match or are similar to the action pattern identified by the action pattern identifying unit 109, from movement histories accumulated in the movement history accumulating unit 113. In addition, the history data extracting unit 112 obtains travel histories that match or are similar to conditions referred to by the action pattern identifying unit 109 upon identifying an action pattern, from the travel histories accumulated in the travel history accumulating unit 106. The history data extracting unit 112 extracts, from the obtained movement histories and travel histories, movement histories in which vehicles have passed through the reference point set by the reference point setting unit 111 and travel histories in which the host vehicle has passed through the reference point set by the reference point setting unit 111.

Furthermore, the history data extracting unit 112 calculates, for the extracted movement histories in which vehicles have passed through the reference point and travel histories in which the host vehicle has passed through the reference point, probabilities of transition indicating probabilities of transition from the reference point to respective points. For example, when a point B has been visited twice via a reference point A and a point C has been visited once via the reference point A, the probability of transition from the reference point A to the point B is 2/3, and the probability of transition from the reference point A to the point C is 1/3.

The movement history accumulating unit 113 accumulates statistical data which is movement histories of a plurality of vehicles collected by an external server, etc. The statistical data which is the movement histories may or may not include the movement histories of the host vehicle. In the movement history accumulating unit 113, information is accumulated that indicates the added up value of the number of times that vehicles have traveled a given route, the added up value of the number of times that vehicles have passed through a given point or facility, etc.

The recommended point obtaining unit 114 obtains, as a first recommended point, a point whose probability of transition from the reference point is greater than or equal to a threshold value, by referring to the movement histories extracted by the history data extracting unit 112. Note that when there are a plurality of points whose probabilities of transition are greater than or equal to the threshold value, first recommended points include the plurality of points.

In addition, the recommended point obtaining unit 114 obtains, as a second recommended point, a point whose probability of transition from the reference point is greater than or equal to a threshold value, by referring to the travel histories extracted by the history data extracting unit 112. Note that when there are a plurality of points whose probabilities of transition are greater than or equal to the threshold value, second recommended points include the plurality of points.

The recommended destination determining unit 115 selects an N₁ top-ranked first recommended point with a high probability of transition among the first recommended points obtained by the recommended point obtaining unit 114, and determines the selected point as a first recommended destination. Likewise, the recommended destination determining unit 115 selects an N₂ top-ranked second recommended point with a high probability of transition among the second recommended points obtained by the recommended point obtaining unit 114, and determines the selected point as a second recommended destination. To present the first recommended destination and the second recommended destination to the occupant of the host vehicle, the recommended destination determining unit 115 performs control to display those on the display 205.

By the recommended destination determining unit 115 performing control to display both the first recommended destination and the second recommended destination, a point where the host vehicle has visited in a daily or non-daily life pattern and a point that is estimated, from action patterns that take similar actions to that of the occupant of the host vehicle, to be likely to be visited are displayed on the display 205. By this, on the basis of the taste of the occupant of the host vehicle, a point where the occupant of the host vehicle have visited in the past can be set as a destination, or a point where, though the occupant of the host vehicle have never visited, other people having similar taste to the occupant of the host vehicle visit frequently can be set as a destination.

Next, exemplary hardware configurations of the information presentation device 100 will be described.

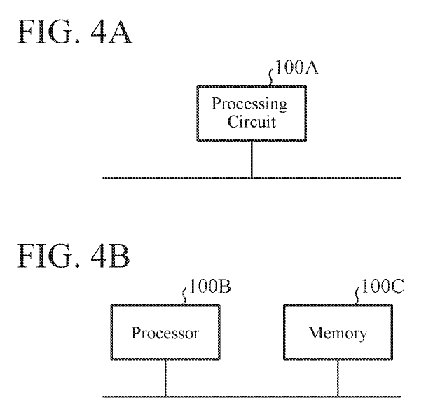

FIGS. 4A and 4B are diagrams showing exemplary hardware configurations of the information presentation device 100 according to the first embodiment.

The occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 of the information presentation device 100 may be, as shown in FIG. 4A, a processing circuit 100A which is dedicated hardware or may be, as shown in FIG. 4B, a processor 100B that executes a program stored in a memory 100C.

When, as shown in FIG. 4A, the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 are dedicated hardware, the processing circuit 100A corresponds, for example, to a single circuit, a combined circuit, a programmed processor, a parallel programmed processor, an application specific integrated circuit (ASIC), a field-programmable gate array (FPGA), or a combination thereof. The functions of the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 may be implemented by respective processing circuits, or the functions of the units may be all together implemented by a single processing circuit.

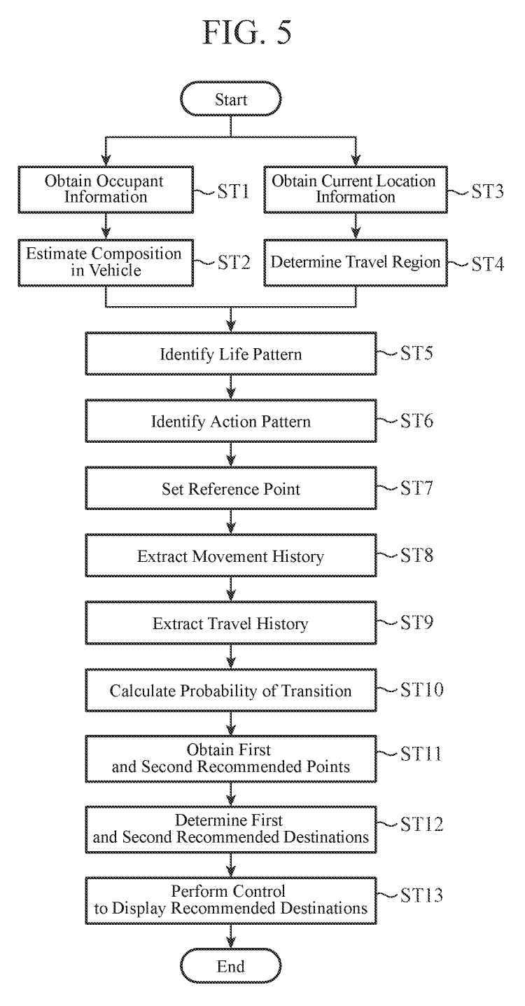

When, as shown in FIG. 4B, the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 are the processor 100B, the functions of the respective units are implemented by software, firmware, or a combination of software and firmware. The software and the firmware are described as programs and stored in the memory 100C. The processor 100B implements the functions of the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 by reading and executing the program stored in the memory 100C. Namely, the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 include the memory 100C for storing programs that, when executed by the processor 100B, consequently perform each step shown in FIG. 5 which will be described later. In addition, it can also be said that the programs cause a computer to perform procedures or methods which the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 use.

Here, the processor 100B is, for example, a central processing unit (CPU), a processing device, an arithmetic device, a processor, a microprocessor, a microcomputer, a digital signal processor (DSP), or the like.

The memory 100C may be, for example, a nonvolatile or volatile semiconductor memory such as a random access memory (RAM), a read only memory (ROM), a flash memory, an erasable programmable ROM (EPROM), or an electrically EPROM (EEPROM), or may be a magnetic disk such as a hard disk or a flexible disk, or may be an optical disc such as a MiniDisc, a compact disc (CD), or a digital versatile disc (DVD).

Note that some of the functions of the occupant information obtaining unit 101, the current location information obtaining unit 102, the in-vehicle composition estimating unit 103, the travel region determining unit 104, the life pattern identifying unit 107, the action pattern identifying unit 109, the reference point setting unit 111, the history data extracting unit 112, the recommended point obtaining unit 114, and the recommended destination determining unit 115 may be implemented by dedicated hardware, and some of the functions may be implemented by software or firmware. As described above, the processing circuit 100A of the information presentation device 100 can implement the above-described functions by hardware, software, firmware, or a combination thereof.

Next, the operation of the information presentation device 100 will be described.

FIG. 5 is a flowchart showing the operation of the information presentation device 100 according to the first embodiment.

When the occupant information obtaining unit 101 obtains occupant information (step ST1), the in-vehicle composition estimating unit 103 estimates occupant composition in the host vehicle on the basis of the occupant information obtained at step ST1 (step ST2). In addition, when the current location information obtaining unit 102 obtains current location information of the host vehicle (step ST3), the travel region determining unit 104 determines whether a travel region of the host vehicle is within or outside a living area, on the basis of the current location information of the host vehicle obtained at step ST3, the map information accumulated in the map information accumulating unit 105, and the travel histories accumulated in the travel history accumulating unit 106 (step ST4).

The life pattern identifying unit 107 identifies a life pattern of the occupant of the host vehicle from the life patterns accumulated in the life pattern accumulating unit 108, on the basis of the occupant composition estimated at step ST2, a result of the determination obtained at step ST4, the travel region of the host vehicle, and time information indicating current time (step ST5). The action pattern identifying unit 109 identifies an action pattern of the occupant of the host vehicle from the action patterns accumulated in the action pattern accumulating unit 110, on the basis of the occupant composition estimated at step ST2, the life pattern identified at step ST5, and the time information (step ST6). The reference point setting unit 111 sets a reference point serving as a reference point upon setting recommended destinations (step ST7).

The history data extracting unit 112 extracts movement histories in which vehicles have passed through the reference point set at step ST7, from the movement histories accumulated in the movement history accumulating unit 113, on the basis of the action pattern identified at step ST6 (step ST8). In addition, the history data extracting unit 112 extracts travel histories in which the host vehicle has passed through the reference point set at step ST7, from the travel histories accumulated in the travel history accumulating unit 106, on the basis of the action pattern identified at step ST6 (step ST9).

The history data extracting unit 112 calculates the probabilities of transition from the reference point to respective points for the movement histories extracted at step ST8 and the travel histories extracted at step ST9 (step ST10). The recommended point obtaining unit 114 obtains first recommended points on the basis of the probabilities of transition for the movement histories which are calculated at step ST10, and obtains second recommended points on the basis of the probabilities of transition for the travel histories which are calculated at step ST10 (step ST11).

The recommended destination determining unit 115 determines, as a first recommended destination, an N top-ranked first recommended point with a high probability of transition among the first recommended points obtained at step ST11, and determines, as a second recommended destination, an N₂ top-ranked second recommended point with a high probability of transition among the second recommended points (step ST12). The recommended destination determining unit 115 performs control to display, on the display 205, the first recommended destination and the second recommended destination which are determined at step ST12, as destinations to be recommended to the occupant of the host vehicle (step ST13), and the process ends.

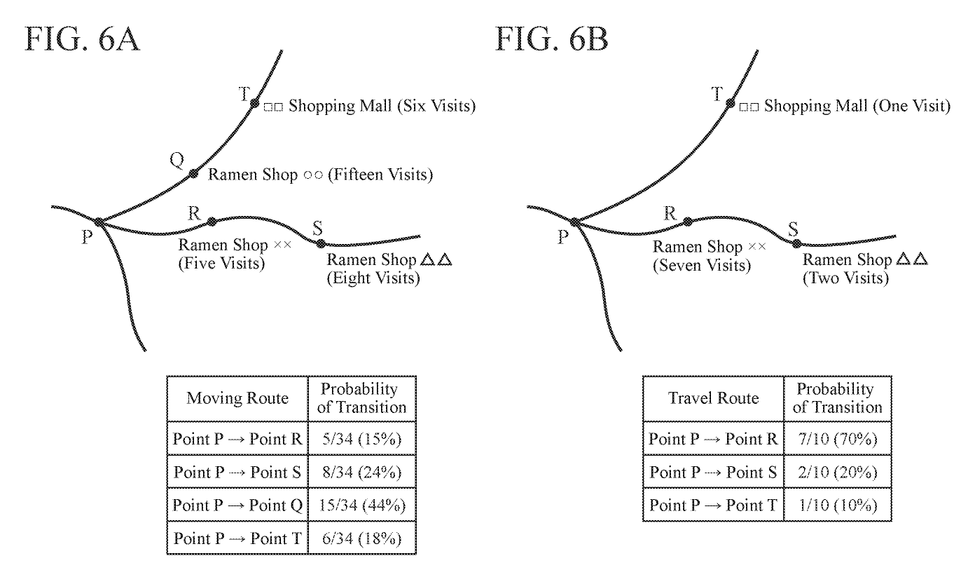

Next, description is made with reference to a specific example shown in FIG. 6 and in accordance with the above-described flowchart of FIG. 5.

FIG. 6 are diagrams showing a specific example showing the processing operation of the information presentation device 100 according to the first embodiment.

First, it is assumed that after performing the process at step ST1, the in-vehicle composition estimating unit 103 estimates at step ST2 that there is one occupant in the host vehicle and ID=1. Then, it is assumed that after performing the process at step ST3, the travel region determining unit 104 determines at step ST4 that a travel region of the host vehicle is within a living area.

At step ST5, in a case where there is one occupant with the ID=1, the host vehicle travels within the living area, and the time slot is 12 pm on a weekend, the life pattern identifying unit 107 determines, by referring to the life patterns accumulated in the life pattern accumulating unit 108 (see FIG. 2), that this case corresponds to one in which the result of determination of a travel region is “within the living area”, the occupant composition is “driver ID 1/2 and with/without a passenger”, the time slot is “weekend and midday”, and the travel region is “F”. Thus, the life pattern identifying unit 107 identifies that the life pattern is “going out on a weekend”.

At step ST6, in a case where there is one occupant with the ID=1, the life pattern is “going out on a weekend”, and the time slot is 12 pm on a weekend, the action pattern identifying unit 109 determines, by referring to the action patterns accumulated in the action pattern accumulating unit 110 (see FIG. 3), that this case corresponds to one in which the life pattern is “going out on a weekend”, the occupant composition is “driver ID=1 and without a passenger”, and the time slot is “weekend and 11:00 to 13:00”. Thus, the action pattern identifying unit 109 identifies that the action pattern is “ramen-fan”. At step ST7, the reference point setting unit 111 sets a point P (see FIG. 6) which is a current location of the vehicle obtained by the current location information obtaining unit 102, as a reference point.

At step ST8, the history data extracting unit 112 obtains movement histories of vehicles of occupants having similar action patterns to the identified action pattern “ramen-fan”, from the movement history accumulating unit 113. Furthermore, the history data extracting unit 112 extracts, from the obtained movement histories, movement histories in which vehicles have passed through the point P.

FIG. 6A is a diagram showing examples of movement histories extracted by the history data extracting unit 112. The movement histories of FIG. 6A show movement histories in which vehicles pass through ramen shops or a shopping mall having a ramen shop after passing through the point P. The movement histories shown in FIG. 6A also show the numbers of visits at each ramen shop and the shopping mall after passing through the point P. The example of FIG. 6A shows that the number of visits at a “ramen shop ◯◯” at a point Q after passing through the point P is fifteen, the number of visits at a “ramen shop xx” at a point R after passing through the point P is five, the number of visits at a “ramen shop ΔΔ” at a point S after passing through the point P is eight, and the number of visits at a “◯◯ shopping mall” at a point T after passing through the point P is six.

At step ST9, the history data extracting unit 112 obtains travel histories that match or are similar to conditions (there is one occupant with the ID=1, the host vehicle travels the living area, and the time slot is 12 pm on a weekend) referred to when the action pattern identifying unit 109 identifies an action pattern, from the travel history accumulating unit 106. Furthermore, the history data extracting unit 112 extracts, from the obtained travel histories, travel histories in which the host vehicle has passed through the point P.

FIG. 6B is a diagram showing examples of travel histories extracted by the history data extracting unit 112. The travel histories of FIG. 6B show travel histories in which the host vehicle passes through the ramen shops or the shopping mall having a ramen shop after passing through the point P. The travel histories shown in FIG. 6B also show the numbers of visits at each ramen shop and the shopping mall after passing through the point P. FIG. 6B shows, for example, that the number of visits at the “ramen shop xx” at the point R after passing through the point P is seven, the number of visits at the “ramen shop ΔΔ” at the point S after passing through the point P is two, and the number of visits at the “DO shopping mall” at the point T after passing through the point P is one.

At step ST10, the history data extracting unit 112 calculates the probabilities of transition for the movement histories and the travel histories.

In the case of the movement histories shown in FIG. 6A, the history data extracting unit 112 calculates the probability of transition from the point P to the point R to be 5/34, the probability of transition from the point P to the point S to be 8/34, the probability of transition from the point P to the point Q to be 15/34, and the probability of transition from the point P to the point R to be 6/34.

In addition, in the case of the travel histories shown in FIG. 6B, the history data extracting unit 112 calculates the probability of transition from the point P to the point R to be 7/10, the probability of transition from the point P to the point S to be 2/10, and the probability of transition from the point P to the point T to be 1/10.

At step ST11, the recommended point obtaining unit 114 obtains, as first recommended points, the point S and the point Q included in a movement history from the point P to the point S and a movement history from the point P to the point Q which are movement histories with a probability of transition of 20% or more.

Likewise, at step ST11, the recommended point obtaining unit 114 obtains, as a second recommended point, the point R included in a travel history from the point P to the point R which is a travel history with a probability of transition of 40% or more.

At step ST12, the recommended destination determining unit 115 determines one (N₁=1) top-ranked point Q with a high probability of transition out of the point S and the point Q which are the first recommended points obtained at step ST11, to be a first recommended destination. Likewise, at step ST12, the recommended destination determining unit 115 recognizes the point R which is the second recommended point obtained at step ST11, as one (N₂₌₁) top-ranked point with a high probability of transition, and determines the point R to be a second recommended destination.

At step ST13, the recommended destination determining unit 115 performs control to display the “ramen shop ◯◯” at the point Q determined to be the first recommended destination and the “ramen shop xx” at the point R determined to be the second recommended destination, as recommended destinations, on the display 205.

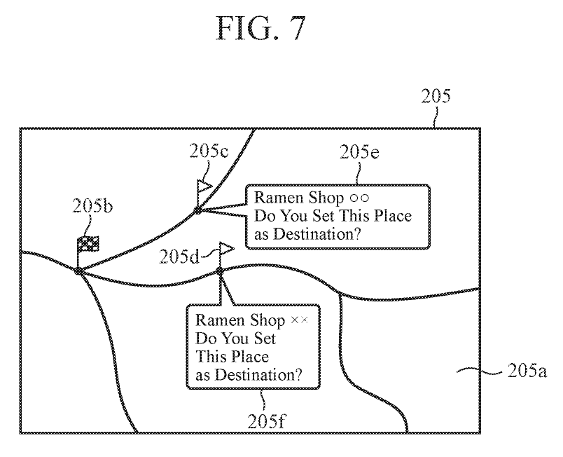

FIG. 7 is a diagram showing exemplary display of the display 205 resulting from display control performed by the recommended destination determining unit 115. On the display 205, map information 205a is displayed, and information 205b indicating the reference point, information 205c indicating the location of the “ramen shop OO”, information 205d indicating the location of the “ramen shop xx”, and information 205e and 205f asking which ramen shop is to be set as a destination are displayed. By the above-described process performed by the information presentation device 100, a destination that the occupant often visits on a daily basis and a destination that occupants of other vehicles similar in action pattern to the occupant often visit are displayed on the display 205. When the occupant of the host vehicle wants a familiar ramen shop, he/she selects the “ramen shop xx” as a destination, and when the occupant of the host vehicle wants to explore a new shop, he/she selects the “ramen shop OO”. In this way, even within the living area, new information can be provided to the occupant.

In addition to the above-described configuration, a result of selection indicating which one of the first recommended destination and the second recommended destination displayed on the display 205 has been selected by the occupant may be reflected in a process of obtaining a next first recommended destination and a next second recommended destination.

For example, a result of selection of recommended destinations inputted through input means (not shown) which is an external device is accumulated in the travel history accumulating unit 106 and the movement history accumulating unit 113. When the travel history accumulating unit 106 and the movement history accumulating unit 113 accumulate the result of selection for each point, the travel history accumulating unit 106 and the movement history accumulating unit 113 additionally accumulate the number of times that the point has been selected as a destination and the number of times that the point has not been selected as a destination, as weight values.

The history data extracting unit 112 obtains weight values added to each point from the travel history accumulating unit 106 and the movement history accumulating unit 113, in addition to calculation of the probability of transition of each point. When the recommended point obtaining unit 114 obtains a first recommended point and a second recommended point, the recommended point obtaining unit 114 also uses the weight values of each point in addition to the probability of transition of each point.

By this, the information presentation device 100 can perform a process in which the frequency of presenting, as a recommended destination, a point whose number of being not selected by the occupant of the host vehicle is large is set to low, a process in which the point is not selected as a presentation target, or the like. By this, presentation of information suited to the occupant's taste can be performed.

The above-described configuration shows that a first recommended destination and a second recommended destination which are determined by the recommended destination determining unit 115 are simultaneously displayed on the display 205. However, it is also possible to preferentially display either one of the recommended destinations and thereafter display the other one of the recommended destinations when there is a request from the occupant.

Description will be made using exemplary display of the display 205 of FIG. 7. For example, on the display 205 that displays the map information 205a and the information 205b indicating the reference point, the information 205c indicating the location of the “ramen shop ◯◯” and the information 205e asking whether to set the ramen shop ◯◯ as a destination are displayed, and display asking whether display of other information is required is further performed. When a user performs input indicating that he/she requires display of other information, then the information 205d indicating the location of the “ramen shop xx” and the information 205f asking whether to set the ramen shop xx as a destination are displayed. Note that the above description is an example, and thus it does not matter which one of the “ramen shop ◯◯” and the “ramen shop xx” is given priority to be displayed.

By this, the information presentation device 100 can cause information that the information presentation device 100 wants to present to the occupant of the host vehicle to be displayed preferentially.

As described above, the first embodiment is configured to include the action pattern identifying unit 109 for identifying, on the basis of at least the occupant composition of the host vehicle and time information, an action pattern of the occupant of the host vehicle from information indicating action patterns estimated from past travel histories of the host vehicle; the history data extracting unit 112 for extracting movement histories in which other vehicles pass through a preset reference point and travel histories in which the host vehicle passes through the reference point, among movement histories of the other vehicles and travel histories of the host vehicle related to the identified action pattern; the recommended point obtaining unit 114 for obtaining a first recommended point on the basis of probabilities of transition indicating probabilities of going to respective points from the reference point in the extracted movement histories, and obtaining a second recommended point on the basis of probabilities of transition indicating probabilities of going to respective points from the reference point in the extracted travel histories; and the recommended destination determining unit 115 for determining a first recommended destination and a second recommended destination to be presented to the occupant of the host vehicle, from the first recommended point and the second recommended point. Thus, information reflecting the taste of the occupant of the host vehicle and information of other people who take similar action patterns to that of the occupant of the host vehicle can be presented. By this, information new to the occupant of the host vehicle can be provided as an option, thus enabling information in which the occupant's demand is flexibly reflected to be presented.

In addition, the first embodiment is configured to include the life pattern identifying unit 107 for identifying whether the occupant of the host vehicle is acting in a daily life pattern or a non-daily life pattern, on the basis of a result of determination as to whether the host vehicle is traveling within a preset area, the occupant composition of the host vehicle, a travel point of the host vehicle, and time information; and the action pattern identifying unit 109 for identifying an action pattern of the occupant by referring to information in which action patterns for the daily life pattern are accumulated or information in which action patterns for the non-daily life pattern are accumulated. Thus, information suited to a life pattern of the occupant of the host vehicle can be presented.

In addition, the first embodiment is configured to collect information indicating whether presented recommended destinations have been selected or not, and to use the collected information upon obtaining next destinations. Thus, the frequency of presentation of information that is recommended to the occupant in the past but is not set as a destination can be reduced or the presentation thereof can be restrained. By this, presentation of information suited to the occupant's taste becomes possible.

Note that although the above-described first embodiment shows a configuration in which the information presentation device 100 includes the map information accumulating unit 105, the travel history accumulating unit 106, the life pattern accumulating unit 108, the action pattern accumulating unit 110, and the movement history accumulating unit 113, a storage area, etc., external to the information presentation device 100 may be used for accumulation.

### Second Embodiment

This second embodiment shows a configuration in which even when it is identified that the host vehicle takes an action pattern different than a daily one, recommended destinations in which occupant's taste is flexibly reflected are presented.

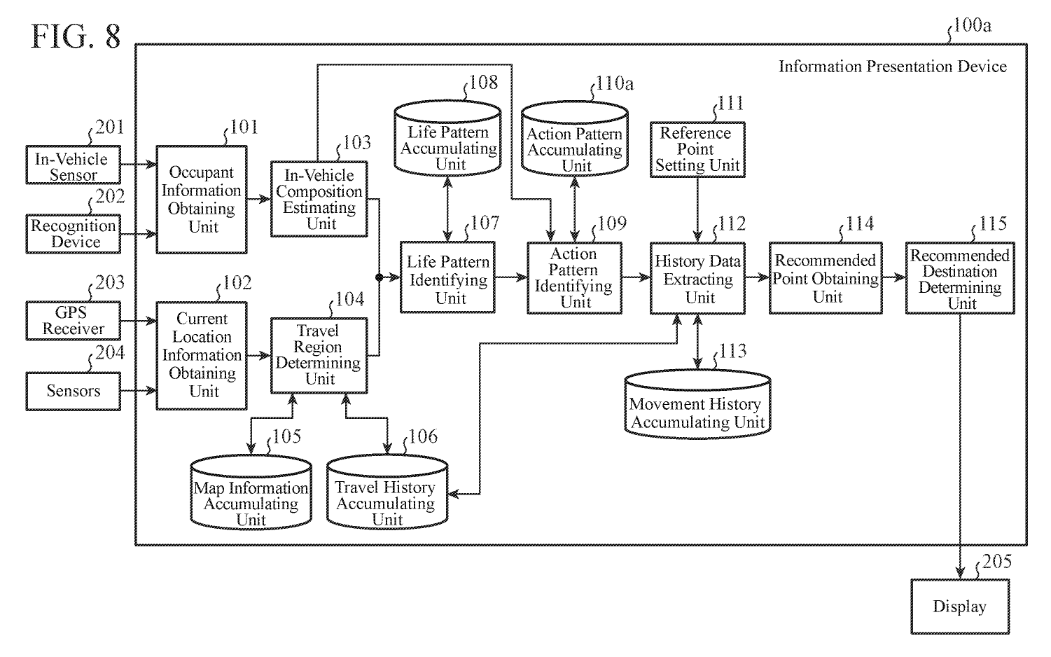

FIG. 8 is a block diagram showing a configuration of an information presentation device 100a according to the second embodiment. The information presentation device 100a according to the second embodiment is configured to include an action pattern accumulating unit 110a instead of the action pattern accumulating unit 110 of the information presentation device 100 shown in the first embodiment.

In the following, the same or corresponding parts as/to the components of the information presentation device 100 according to the first embodiment are denoted by the same reference signs as those used in the first embodiment, and description thereof is omitted or simplified.

As in the first embodiment, the action pattern accumulating unit 110a accumulates information indicating the past action patterns of occupants of the host vehicle. Furthermore, when a life pattern is a non-daily pattern such as a business trip or travel, the action pattern accumulating unit 110a accumulates an action pattern indicating a tendency of action taken by occupants of the host vehicle in the non-daily life pattern. For example, when there is a pattern in which, e.g., the amount of money spent on meals and shopping increases on family travel of occupants of the host vehicle, an action pattern indicating “expensive taste” is accumulated in an action pattern.

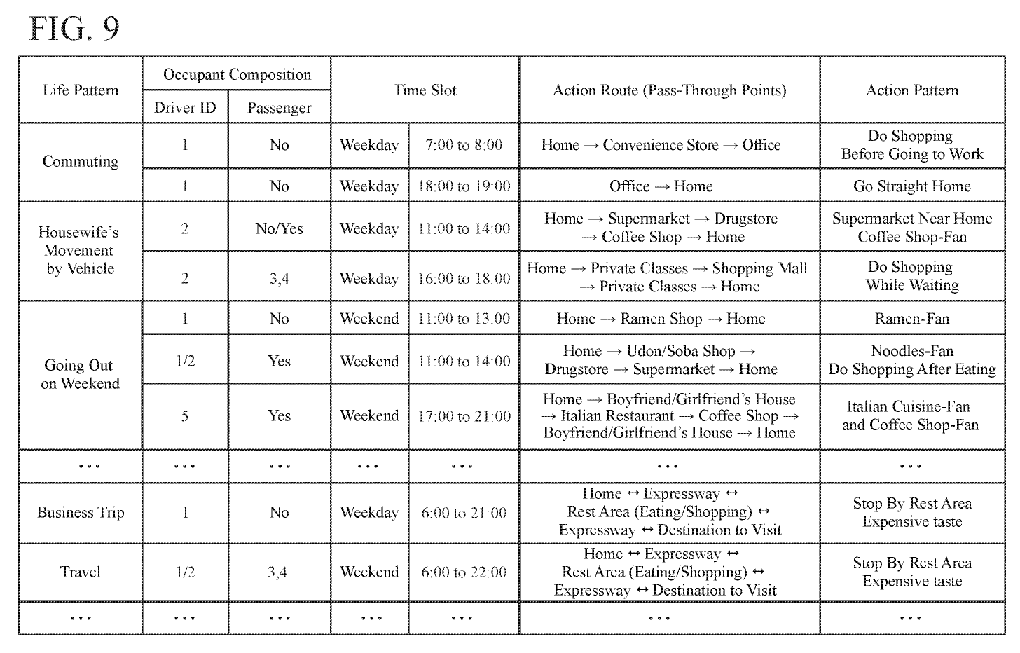

FIG. 9 is a diagram showing examples of action patterns accumulated in the action pattern accumulating unit 110a of the information presentation device 100a according to the second embodiment.

An action pattern indicating expensive taste is added to action patterns for the life patterns “business trip” and “travel” whose travel regions are outside the living area, because those are non-daily.

As in the first embodiment, the action pattern identifying unit 109 identifies a current action pattern of the occupant of the host vehicle from the past action patterns of occupants accumulated in the action pattern accumulating unit 110a, on the basis of a life pattern identified by the life pattern identifying unit 107, the occupant composition in the vehicle estimated by the in-vehicle composition estimating unit 103, and time information indicating current time. The action pattern identifying unit 109 identifies, for example, that the action pattern of the occupant of the host vehicle is “travel: stop by a rest area and expensive taste”, by referring to the action patterns shown in FIG. 9.

As in the first embodiment, the history data extracting unit 112 extracts movement histories in which vehicles have passed through a reference point and travel histories in which the host vehicle has passed through the reference point, from movement histories accumulated in the movement history accumulating unit 113 and travel histories accumulated in the travel history accumulating unit 106. Note that when the host vehicle is traveling outside the living area, travel histories in which the host vehicle has passed through the reference point may not be accumulated in the travel history accumulating unit 106. In that case, the history data extracting unit 112 extracts movement histories for action patterns that match or are similar to the action pattern identified by the action pattern identifying unit 109, by referring to only the movement history accumulating unit 113.

The processing operation of the information presentation device 100a is the same as that of the first embodiment, and thus description thereof is omitted or simplified.

As described above, according to the second embodiment, the action pattern identifying unit 109 is configured to refer to information in which an action pattern indicating the action tendency of the occupant of the host vehicle in a non-daily life pattern is accumulated. Thus, even when the occupant of the host vehicle take a non-daily life pattern such as a business trip or travel, taste of the occupant of the host vehicle can be flexibly reflected.

### Third Embodiment

This third embodiment shows a configuration in which destinations to be recommended are determined using also the condition of a driver of the host vehicle.

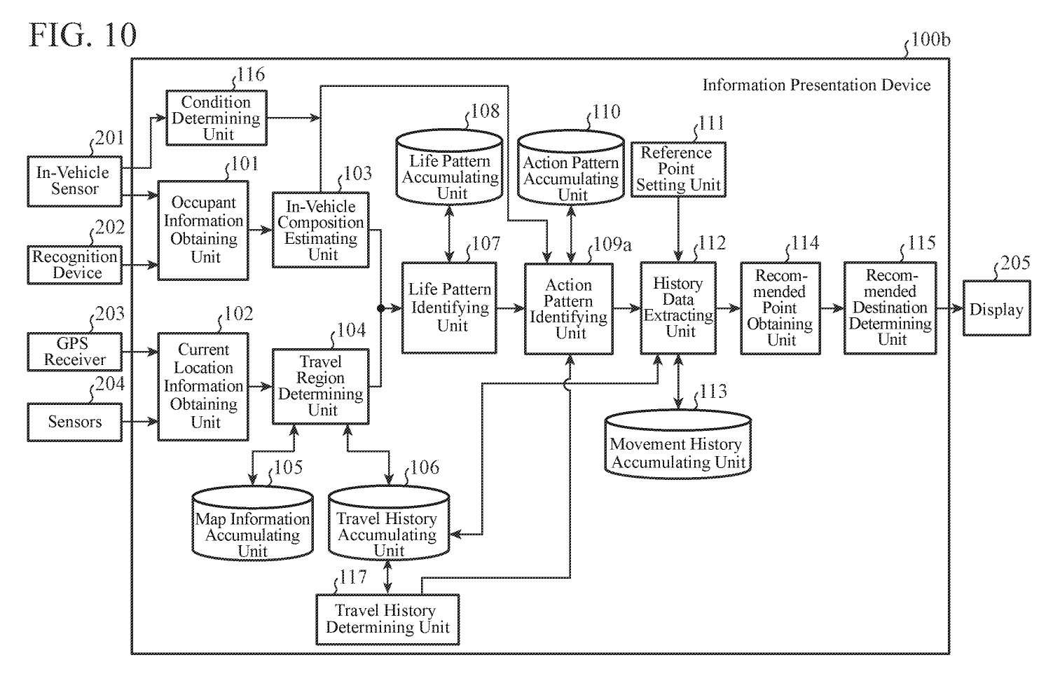

FIG. 10 is a block diagram showing a configuration of an information presentation device 100b according to the third embodiment. The information presentation device 100b according to the third embodiment is configured so that a condition determining unit 116 and a travel history determining unit 117 are additionally provided to the information presentation device 100 shown in the first embodiment, and an action pattern identifying unit 109a is included instead of the action pattern identifying unit 109.

In the following, the same or corresponding parts as/to the components of the information presentation device 100 according to the first embodiment are denoted by the same reference signs as those used in the first embodiment, and description thereof is omitted or simplified.

The condition determining unit 116 determines the driver's condition by analyzing captured images obtained by the in-vehicle sensor 201. For example, the condition determining unit 116 identifies the driver's face, eyes on the face, a nose on the face, and a mouth on the face from results of the analysis. Then, the condition determining unit 116 determines whether the driver is dozing or has drowsiness, by obtaining the duration of eyelid closure and the number of blinks by focusing on the identified driver's eyes. In addition, the condition determining unit 116 determines whether the driver is dozing or has drowsiness, by obtaining the number of yawns from the results of the analysis by focusing on the driver's mouth.

Furthermore, the condition determining unit 116 calculates the line-of-sight direction of the driver from the positions of the driver's eyes, nose, and mouse. When the calculated line-of-sight direction is oriented in a different direction than a traveling direction of the host vehicle, the condition determining unit 116 determines that the driver is looking away. The condition determining unit 116 calculates the frequency of opening and closing of the driver's mouth from the results of the analysis, and thereby detects changes in the calculated frequency of opening and closing of the mouth. When the frequency of opening and closing of the mouth has decreased, the condition determining unit 116 determines that conversation in the vehicle is reduced and the driver is tired.

When the condition determining unit 116 determines that the driver is dozing, the driver has drowsiness, the driver is looking away, the driver is tired, etc., the condition determining unit 116 notifies the action pattern identifying unit 109a of a result of the determination that indicates the driver's condition is not suitable for driving.

Although the above description shows a configuration in which the condition determining unit 116 determines the driver's condition, a passenger in a front seat of the host vehicle and a passenger in a rear seat of the host vehicle may also be added likewise as determination targets. In this case, the driver and all passengers may be captured by a single in-vehicle sensor 201 or may be captured using a plurality of sensors.

The travel history accumulating unit 106 accumulates past travel histories of the host vehicle, and accumulates histories of the driver's condition together with the past travel histories. For example, when the driver has performed an undesirable driving operation at a given point, such a fact is accumulated so as to be associated with the point.

The travel history determining unit 117 determines whether a point at which an undesirable driving operation, such as dozing off at the wheel or looking away while driving, has been performed in the past is present in a region within a predetermined range from a current location obtained by the current location information obtaining unit 102, by referring to the past travel histories of the driver accumulated in the travel history accumulating unit 106. When the point at which an undesirable driving operation has been performed is present, the travel history determining unit 117 notifies the action pattern identifying unit 109a of the fact that the driver is scheduled to travel a region where an undesirable driving operation has been performed in the past.

The action pattern identifying unit 109a determines whether the action pattern identifying unit 109a has been notified by the condition determining unit 116 that the driver's condition is not suitable for driving, and whether the action pattern identifying unit 109a has been notified by the travel history determining unit 117 that the driver is scheduled to travel a region where an undesirable driving operation has been performed in the past, in addition to the process shown in the first embodiment. When the action pattern identifying unit 109a determines that the action pattern identifying unit 109a has been notified that the driver's condition is not suitable for driving, or when the action pattern identifying unit 109a determines that the action pattern identifying unit 109a has been notified that the driver is scheduled to travel a region where an undesirable driving operation has been performed in the past, the action pattern identifying unit 109a adds a condition for causing the driver to rest, e.g., a condition such as “break”, to an action pattern identified by the same process as that of the first embodiment.

The history data extracting unit 112 extracts movement histories for action patterns that match or are similar to the action pattern added with the condition for causing the driver to rest, from movement histories accumulated in the movement history accumulating unit 113. The history data extracting unit 112 extracts travel histories that match or are similar to the action pattern added with the condition for causing the driver to rest, from travel histories accumulated in the travel history accumulating unit 106. It is assumed that in the movement history accumulating unit 113 and the travel history accumulating unit 106, for example, movement histories for a case of taking a “break” are accumulated.

The recommended point obtaining unit 114 and the recommended destination determining unit 115 perform the same processes as those of the first embodiment.

Next, exemplary hardware configurations of the information presentation device 100b will be described. Note that diagrams showing exemplary hardware configurations of the information presentation device 100b of the third embodiment are the same as FIGS. 4A and 4B shown in the first embodiment, and thus, graphical representation thereof is omitted. In addition, description of the same components as those of the first embodiment is also omitted.

The action pattern identifying unit 109a, the condition determining unit 116, and the travel history determining unit 117 of the information presentation device 100b may be, as shown in FIG. 4A, a processing circuit 100A which is dedicated hardware or may be, as shown in FIG. 4B, a processor 100B that executes a program stored in a memory 100C.

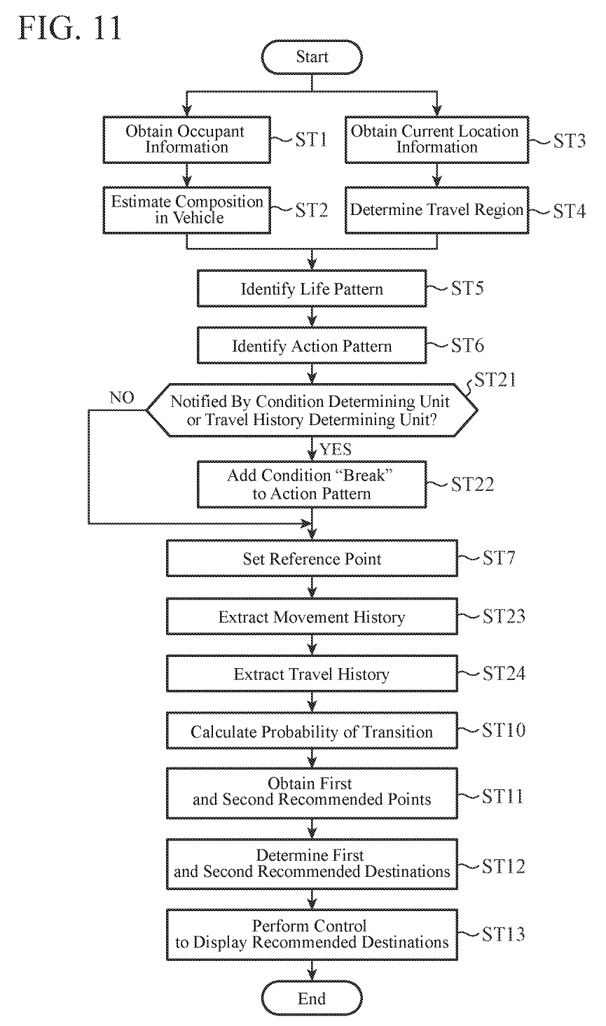

In addition, when, as shown in FIG. 4B, the action pattern identifying unit 109a, the condition determining unit 116, and the travel history determining unit 117 are the processor 100B, the functions of the action pattern identifying unit 109a, the condition determining unit 116, and the travel history determining unit 117 are implemented by software, firmware, or a combination of software and firmware. The software and the firmware are described as programs and stored in the memory 100C. The processor 100B implements the functions of the action pattern identifying unit 109a, the condition determining unit 116, and the travel history determining unit 117 by reading and executing the program stored in the memory 100C. Namely, the action pattern identifying unit 109a, the condition determining unit 116, and the travel history determining unit 117 include the memory 100C for storing programs that, when executed by the processor 100B, consequently perform each step shown in FIG. 11 which will be described later. In addition, it can also be said that the programs cause a computer to perform procedures or methods which the action pattern identifying unit 109a, the condition determining unit 116, and the travel history determining unit 117 use.

Note that some of the functions of the action pattern identifying unit 109a, the condition determining unit 116, and the travel history determining unit 117 may be implemented by dedicated hardware, and some of the functions may be implemented by software or firmware. As described above, the processing circuit 100A of the information presentation device 100b can implement the above-described functions by hardware, software, firmware, or a combination thereof.

Next, the processing operation of the information presentation device 100b will be described.

FIG. 11 is a flowchart showing the operation of the information presentation device 100b according to the third embodiment. In FIG. 11, the same steps as those of the flowchart of the first embodiment shown in FIG. 5 are denoted by the same reference signs and description thereof is omitted.

Note that it is assumed that the condition determining unit 116 determines the driver's condition at all times. Likewise, description is made assuming that the travel history determining unit 117 performs determination using past travel histories for a travel region of the host vehicle at all times. In addition, an example case is described in which the action pattern identifying unit 109a adds the condition “break” to an action pattern, as a condition for causing the driver to rest.

When, at step ST6, the action pattern identifying unit 109a identifies an action pattern of an occupant of the host vehicle, the action pattern identifying unit 109a further determines whether the action pattern identifying unit 109a has been notified by the condition determining unit 116 that the driver's condition is not suitable for driving, and whether the action pattern identifying unit 109a has been notified by the travel history determining unit 117 that the driver is scheduled to travel a region where an undesirable driving operation has been performed in the past (step ST21). If there is no notification (step ST21; NO), processing proceeds to step ST7. On the other hand, if notified that the driver's condition is not suitable for driving or if notified that the driver is scheduled to travel a region where an undesirable driving operation has been performed in the past (step ST21; YES), the action pattern identifying unit 109a adds the condition “break” to the action pattern identified at step ST6 (step ST22).

The reference point setting unit 111 sets a reference point serving as a reference point upon setting destinations (step ST7). The history data extracting unit 112 extracts movement histories in which vehicles have passed through the reference point set at step ST7, from the movement histories accumulated in the movement history accumulating unit 113, on the basis of the action pattern to which the condition “break” is added at step ST22 (step ST23). In addition, the history data extracting unit 112 extracts travel histories in which the host vehicle has passed through the reference point set at step ST7, from the travel histories accumulated in the travel history accumulating unit 106, on the basis of the action pattern to which the condition “break” is added at step ST22 (step ST24).

The history data extracting unit 112 calculates the probabilities of transition from the reference point to respective points for the movement histories extracted at step ST23 and the travel histories extracted at step ST24 (step ST10). Thereafter, the processes at steps ST11 to ST13 are performed, and the flowchart reaches the end thereof.

The above-described description shows an example in which the action pattern identifying unit 109a adds a condition for causing the driver to rest to an identified action pattern. In addition to that, the action pattern identifying unit 109a may add a condition for providing serendipity to the driver to an identified action pattern. The condition for providing serendipity to the driver is, for example, a condition for the driver to experience unexpected nice events or to discover unexpected things. Although here description is made with the driver being a target, a condition for providing serendipity to all occupants of the host vehicle may be added.

When the action pattern identifying unit 109a determines that the action pattern identifying unit 109a has been notified by the condition determining unit 116 that the driver's condition is not suitable for driving, or that the action pattern identifying unit 109a has been notified by the travel history determining unit 117 that the driver is scheduled to travel a region where an undesirable driving operation has been performed in the past, a condition for providing serendipity to the driver, e.g., the condition “stop by a newly opened restaurant that seems to suit driver's taste” or “stop by a shop that seems to suit driver's taste during a trip”, is added to an action pattern identified by the same process as that of the first embodiment.

The history data extracting unit 112 extracts movement histories for action patterns that match or are similar to the action pattern added with the condition for providing serendipity to the driver, from the travel histories accumulated in the movement history accumulating unit 113. When the condition for providing serendipity to the driver is added, in order to extract points where occupants of the host vehicle have never been, the history data extracting unit 112 refers to only the movement history accumulating unit 113 and does not refer to the travel history accumulating unit 106. The recommended point obtaining unit 114 and the recommended destination determining unit 115 perform the same processes as those of the first embodiment.

As described above, the third embodiment is configured so that there is included the condition determining unit 116 for determining the condition of the driver of the host vehicle, and the action pattern identifying unit 109a adds a new action pattern to an identified action pattern when the condition determining unit 116 determines that the condition of the driver is not suitable for driving. Thus, a new condition can be presented depending on the condition of the driver.

Specifically, since the action pattern identifying unit 109a is configured to add an action pattern for causing the driver to rest, as a new action pattern, a condition for causing the driver to rest can be presented depending on the condition of the driver. By this, the driver can be restrained from continuously driving with his/her condition being not suitable for driving.

In addition, the third embodiment is configured so that there is included the travel history determining unit 117 for determining, by referring to travel histories of the driver of the host vehicle, whether a point at which the driver has performed a specific driving operation in the past is present in a region within a predetermined range from a current location of the host vehicle, and the action pattern identifying unit 109a adds a new action pattern to an identified action pattern when the travel history determining unit 117 determines that the point is present. Thus, a new condition can be presented depending on the travel histories of the driver.

Specifically, since the action pattern identifying unit 109a is configured to add an action pattern for causing the driver to rest, as a new action pattern, information for causing the driver to rest can be presented depending on the condition of the driver. By this, the driver can be restrained from performing an undesirable driving operation.

In addition, according to the third embodiment, the action pattern identifying unit 109a is configured to add, as a new action pattern, an action pattern for providing serendipity to the driver or an occupant of the host vehicle to an identified action pattern when the condition determining unit 116 determines that the driver's condition is not suitable for driving or when the travel history determining unit 117 determines that the point is present. Thus, information for experiencing unexpected nice events or information for discovering unexpected things can be presented to the driver or the occupant of the host vehicle.

In addition, although the above-described third embodiment shows a configuration including the condition determining unit 116 and the travel history determining unit 117, only the condition determining unit 116 may be included or only the travel history determining unit 117 may be included.

In addition, although the above-described third embodiment shows a configuration in which the condition determining unit 116 and the travel history determining unit 117 are additionally provided to the information presentation device 100 shown in the first embodiment, the condition determining unit 116 and the travel history determining unit 117 may be additionally provided to the information presentation device 100a shown in the second embodiment.

### Fourth Embodiment

This fourth embodiment shows an information presentation system configured by the information presentation devices 100, 100a, and 100b shown in the first to third embodiments in cooperation with a server device.

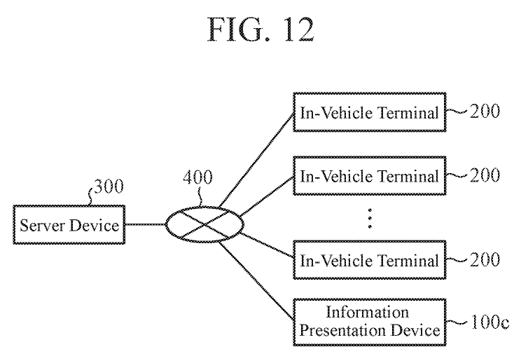

FIG. 12 is a diagram showing an overview of the information presentation system according to the fourth embodiment.

Note that in the following an information presentation system that employs the configuration of the information presentation device 100 of the first embodiment is described as an example.

The information presentation system includes a plurality of in-vehicle terminals 200, a server device 300, and an information presentation device 100c. Although FIG. 12 shows an example in which a single information presentation device 100c is included, it is also possible to employ a configuration in which information is presented to a plurality of information presentation devices. The in-vehicle terminals 200 and the server device 300 are connected to each other through a communication network 400, and the server device 300 and the information presentation device 100 are also likewise connected to each other through the communication network 400.

Each in-vehicle terminal 200 is composed of, for example, a navigation device mounted on a vehicle. The in-vehicle terminal 200 collects information indicating movement histories of the vehicle having the in-vehicle terminal 200 mounted thereon, and transmits the information as probe information to the server device 300 through the communication network 400.

The information presentation device 100c performs a process of presenting information shown in the first embodiment, by referring to information accumulated in the server device 300.

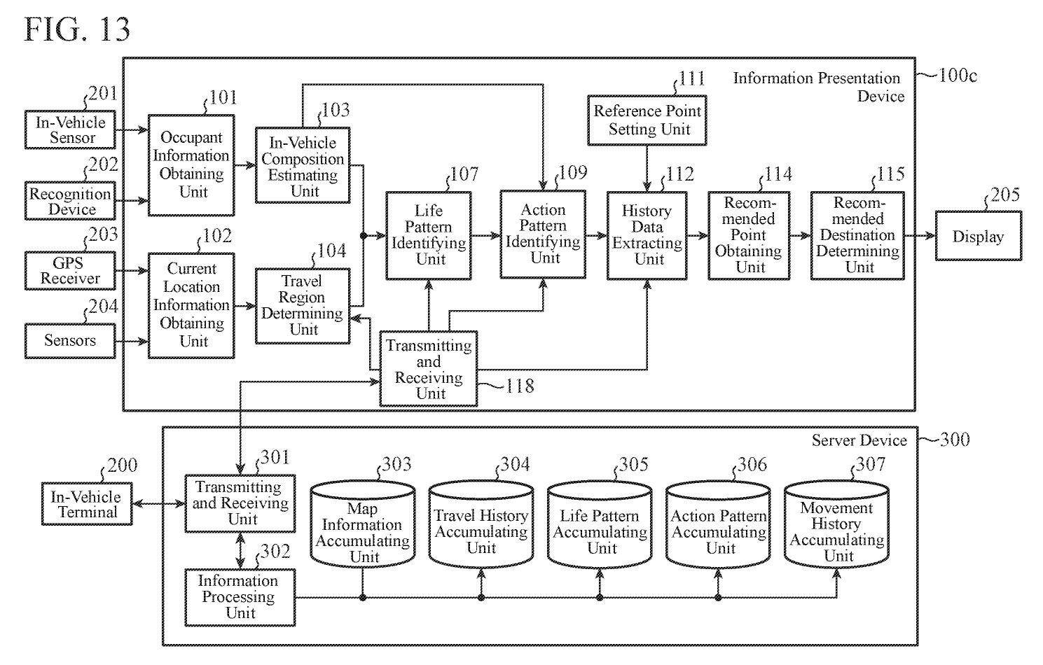

FIG. 13 is a block diagram showing configurations of the server device 300 and the information presentation device 100c of the information presentation system according to the fourth embodiment. Note that for the information presentation device 100c, the same or corresponding parts as/to the components of the information presentation device 100 according to the first embodiment are denoted by the same reference signs as those used in the first embodiment, and description thereof is omitted or simplified.

The server device 300 includes a transmitting and receiving unit 301, an information processing unit 302, a map information accumulating unit 303, a travel history accumulating unit 304, a life pattern accumulating unit 305, an action pattern accumulating unit 306, and a movement history accumulating unit 307. The transmitting and receiving unit 301 performs transmission and reception of information with the in-vehicle terminals 200 and the information presentation device 100c.

The transmitting and receiving unit 301 performs transmission and reception of data with the plurality of in-vehicle terminals 200 and the information presentation device 100c through the communication network 400. The information processing unit 302 extracts vehicle-by-vehicle travel histories from information inputted from the plurality of in-vehicle terminals 200, and accumulates the vehicle-by-vehicle travel histories in the travel history accumulating unit 304 per vehicle. The information processing unit 302 extracts vehicle-by-vehicle life patterns of occupants from information inputted from the plurality of in-vehicle terminals 200, and accumulates the vehicle-by-vehicle life patterns in the life pattern accumulating unit 305 per vehicle. The information processing unit 302 extracts vehicle-by-vehicle action patterns of occupants from information inputted from the plurality of in-vehicle terminals 200, and accumulates the vehicle-by-vehicle action patterns in the action pattern accumulating unit 306 per vehicle. The information processing unit 302 obtains statistical data which is movement histories of a plurality of vehicles from information inputted from the plurality of in-vehicle terminals 200, and accumulates the statistical data in the movement history accumulating unit 307.

Information accumulated in the map information accumulating unit 303, the travel history accumulating unit 304, the life pattern accumulating unit 305, the action pattern accumulating unit 306, and the movement history accumulating unit 307 is the same as information accumulated in the map information accumulating unit 105, the travel history accumulating unit 106, the life pattern accumulating unit 108, the action pattern accumulating unit 110, and the movement history accumulating unit 113 of the information presentation device 100 shown in the first embodiment, and thus, a detailed description thereof is omitted.

The information presentation device 100c is configured so that the map information accumulating unit 105, the travel history accumulating unit 106, the life pattern accumulating unit 108, the action pattern accumulating unit 110, and the movement history accumulating unit 113 are not provided in the information presentation device 100 shown in FIG. 1. Information to be referred to by the travel region determining unit 104, the life pattern identifying unit 107, the action pattern identifying unit 109, and the history data extracting unit 112 is obtained from the server device 300 through a transmitting and receiving unit 118. The travel region determining unit 104, the life pattern identifying unit 107, the action pattern identifying unit 109, and the history data extracting unit 112 store the information obtained from the server device 300 in a temporary storage area such as a buffer (not shown), and refer to the information. Note that each component of the information presentation device 100c is the same as that of the first embodiment, and thus a detailed description thereof is omitted.

Next, exemplary hardware configurations of the information presentation device 100c will be described. Note that diagrams showing exemplary hardware configurations of the information presentation device 100c of the fourth embodiment are the same as FIGS. 4A and 4B shown in the first embodiment, and thus, graphical representation thereof is omitted. In addition, description of the same components as those of the first embodiment is also omitted.

The transmitting and receiving unit 118 of the information presentation device 100c may be, as shown in FIG. 4A, a processing circuit 100A which is dedicated hardware or may be, as shown in FIG. 4B, a processor 100B that executes a program stored in a memory 100C.

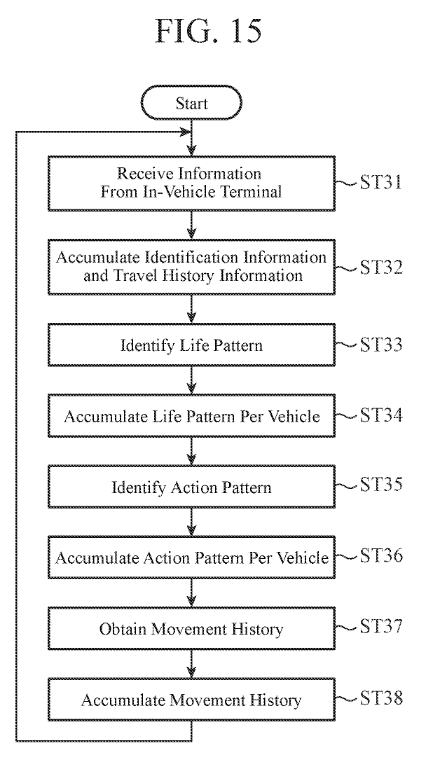

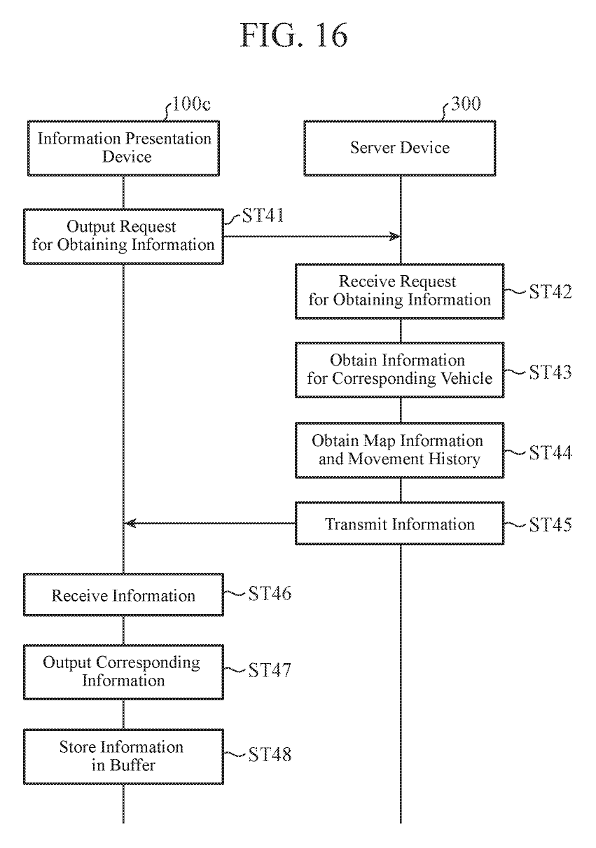

In addition, when, as shown in FIG. 4B, the transmitting and receiving unit 118 is the processor 100B, the function of the transmitting and receiving unit 118 is implemented by software, firmware, or a combination of software and firmware. The software and the firmware are described as programs and stored in the memory 100C. The processor 100B implements the function of the transmitting and receiving unit 118 by reading and executing the program stored in the memory 100C. Namely, the transmitting and receiving unit 118 includes the memory 100C for storing programs that, when executed by the processor 100B, consequently perform each step shown in FIGS. 15 and 16 which will be described later. In addition, it can also be said that the programs cause a computer to perform procedures or methods which the transmitting and receiving unit 118 uses.

Note that a part of the function of the transmitting and receiving unit 118 may be implemented by dedicated hardware, and another part of the function may be implemented by software or firmware. As described above, the processing circuit 100A of the information presentation device 100c can implement the above-described functions by hardware, software, firmware, or a combination thereof.

Next, exemplary hardware configurations of the server device 300 will be described.

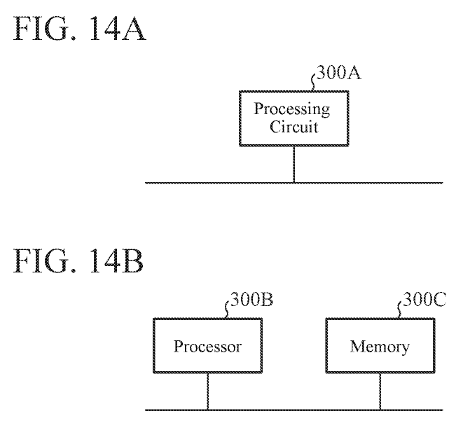

FIGS. 14A and 14B are diagrams showing exemplary hardware configurations of the server device 300 according to the fourth embodiment.

The transmitting and receiving unit 301 and the information processing unit 302 of the server device 300 may be, as shown in FIG. 14A, a processing circuit 300A which is dedicated hardware or may be, as shown in FIG. 14B, a processor 300B that executes a program stored in a memory 300C.

When, as shown in FIG. 14A, the transmitting and receiving unit 301 and the information processing unit 302 are dedicated hardware, the processing circuit 100A corresponds, for example, to a single circuit, a combined circuit, a programmed processor, a parallel programmed processor, an ASIC, an FPGA, or a combination thereof. The functions of the transmitting and receiving unit 301 and the information processing unit 302 may be implemented by respective processing circuits, or the functions of the units may be all together implemented by a single processing circuit.

When, as shown in FIG. 14B, the transmitting and receiving unit 301 and the information processing unit 302 are the processor 300B, the functions of the respective units are implemented by software, firmware, or a combination of software and firmware. The software and the firmware are described as programs and stored in the memory 300C. The processor 300B implements the functions of the transmitting and receiving unit 301 and the information processing unit 302 by reading and executing the program stored in the memory 300C. Namely, the transmitting and receiving unit 301 and the information processing unit 302 include the memory 300C for storing programs that, when executed by the processor 300B, consequently perform each step shown in FIGS. 15 and 16 which will be described later. In addition, it can also be said that the programs cause a computer to perform procedures or methods which the transmitting and receiving unit 301 and the information processing unit 302 use.

Next, the processing operation of the information presentation system will be described.

In the following, as the processing operation of the information presentation system, a process of collecting information from the plurality of in-vehicle terminals 200 and accumulating the information in the server device 300 and a process of transmitting and receiving information between the server device 300 and the information presentation device 100c are separately described.

First, with reference to FIG. 15, a process of accumulating information performed by the server device 300 will be described.

FIG. 15 is a flowchart showing the operation of the server device 300 in the information presentation system according to the fourth embodiment.

The transmitting and receiving unit 301 of the server device 300 receives pieces of information transmitted from the in-vehicle terminals 200 (step ST31). Each of the pieces of information transmitted from the in-vehicle terminals 200 is information in which identification information for identifying a vehicle, user ID information for identifying an occupant in the vehicle, user information indicating a home of the occupant of the vehicle, etc., information indicating travel histories of the vehicle, time information, and the like, are associated with each other. The pieces of information transmitted from the in-vehicle terminals 200 are not limited to the above-described information and can be set as appropriate. The information processing unit 302 accumulates the pieces of identification information for identifying vehicles and the pieces of information indicating travel histories of the vehicles among the pieces of information received at step ST31 in the travel history accumulating unit 304 so that the pieces of identification information and respective pieces of information indicating travel histories are linked to each other (step ST32).

The information processing unit 302 identifies life patterns of occupants per vehicle from the pieces of information received at step ST31 (step ST33). The information processing unit 302 accumulates the life patterns of the occupants identified at step ST33 in the life pattern accumulating unit 305 so that the life patterns are classified by vehicle (step ST34). The information accumulated in the life pattern accumulating unit 305 is, for example, the information shown in FIG. 2 in the first embodiment.

The information processing unit 302 identifies action patterns for respective life patterns identified at step ST33 from the pieces of information received at step ST32 (step ST35). The information processing unit 302 accumulates the action patterns of the occupants identified at step ST35 in the action pattern accumulating unit 306 so that the action patterns are classified by vehicle (step ST36). The information accumulated in the action pattern accumulating unit 306 is, for example, the information shown in FIG. 3 in the first embodiment.

The information processing unit 302 examines the pieces of information indicating the travel histories of the plurality of vehicles and received at step ST31, and thereby obtains movement histories which are statistical data on travel of the plurality of vehicles (step ST37), and accumulates the movement histories in the movement history accumulating unit 307 (step ST38). Thereafter, the process returns to the process at step ST1.

Next, with reference to FIG. 16, transmission and reception of information between the server device 300 and the information presentation device 100c will be described.

FIG. 16 is a sequence diagram showing the operation of the information presentation system according to the fourth embodiment.

The information presentation device 100c outputs a request for obtaining information to the server device 300 (step ST41). It is assumed that the request for obtaining information outputted from the information presentation device 100c includes at least identification information for identifying a host vehicle and current location information of the host vehicle. When the transmitting and receiving unit 301 of the server device 300 receives the request for obtaining information outputted at step ST41 (step ST42), the information processing unit 302 obtains data on travel histories of a corresponding vehicle, data on life patterns of the corresponding vehicle, and data on action patterns of the corresponding vehicle from the travel history accumulating unit 304, the life pattern accumulating unit 305, and the action pattern accumulating unit 306, on the basis of the request for obtaining information (step ST43). In addition, the information processing unit 302 obtains map information for a corresponding region from the map information accumulating unit 303 and obtains movement histories for the corresponding region from the movement history accumulating unit 307, on the basis of the current location information (step ST44).

The information processing unit 302 transmits the information obtained at step ST43 and ST44 to the information presentation device 100c through the transmitting and receiving unit 301 (step ST45). When the transmitting and receiving unit 118 of the information presentation device 100c receives the information transmitted at step ST45 (step ST46), corresponding information is outputted to each of the travel region determining unit 104, the life pattern identifying unit 107, the action pattern identifying unit 109, and the history data extracting unit 112 (step ST47). The travel region determining unit 104, the life pattern identifying unit 107, the action pattern identifying unit 109, and the history data extracting unit 112 store the inputted information in a buffer, etc. (not shown) (step ST48), and the process ends.

In the information presentation device 100 of the first embodiment, upon performing a process of presenting information shown in the flowchart of FIG. 5, information obtained from the map information accumulating unit 105, the travel history accumulating unit 106, the life pattern accumulating unit 108, the action pattern accumulating unit 110, and the movement history accumulating unit 113 is referred to. On the other hand, in the information presentation device 100c of the fourth embodiment, the information stored in the buffer at step ST48 of the sequence diagram of FIG. 16 is referred to. Other processing operation of the information presentation device 100c is the same as that of the first embodiment, and thus a detailed description thereof is omitted.

As described above, the fourth embodiment is configured so that movement histories are collected from a plurality of vehicles having in-vehicle terminals mounted thereon. Thus, movement histories which are statistical data obtained by examining information collected from the plurality of vehicles can be obtained, thus enabling useful information suited to the occupant's demand to be presented.

In addition to the above description, in the present invention, a free combination of the embodiments, modifications to any component of the embodiments, or omissions of any component in the embodiments are possible within the scope of the invention.

### INDUSTRIAL APPLICABILITY

Information presentation devices according to the invention can provide information in which an occupant's demand is flexibly reflected. Thus, the information presentation devices can be used to improve the accuracy of recommendation of information to be recommended to the occupant by using the information presentation devices for an in-vehicle device such as a navigation device.

### REFERENCE SIGNS LIST

100, 100a, 100b, and 100c: Information presentation device, 101: Occupant information obtaining unit, 102: Current location information obtaining unit, 103: In-vehicle composition estimating unit, 104: Travel region determining unit, 105 and 303: Map information accumulating unit, 106 and 304: Travel history accumulating unit, 107: Life pattern identifying unit, 108 and 305: Life pattern accumulating unit, 109 and 109a: Action pattern identifying unit, 110, 100a, and 306: Action pattern accumulating unit, 111: Reference point setting unit, 112: History data extracting unit, 113 and 307: Movement history accumulating unit, 114: Recommended point obtaining unit, 115: Recommended destination determining unit, 116: Condition determining unit, 117: Travel history determining unit, 118 and 301: Transmitting and receiving unit, 200: In-vehicle terminal, 201: In-vehicle sensor, 202: Recognition device, 203: GPS receiver, 204: Sensor, 205: Display, 300: Server device, and 302: Information processing unit

1. An information presentation device comprising:
a processor to execute a program; and
a memory to store the program which, when executed by the processor, performs processes of,
identifying, on a basis of at least occupant composition of a host vehicle and time information, an action pattern of an occupant of the host vehicle from information indicating action patterns estimated from past travel histories of the host vehicle;
extracting movement histories in which other vehicles pass through a reference point and travel histories in which the host vehicle passes through the reference point, among movement histories of the other vehicles and travel histories of the host vehicle related to the action pattern identified, the reference point being a current location of the host vehicle or an already set destination;
obtaining a first recommended point on a basis of probabilities of transition indicating probabilities of going to respective points from the reference point in the movement histories extracted;
obtaining a second recommended point on a basis of probabilities of transition indicating probabilities of going to respective points from the reference point in the travel histories extracted; and
determining a first recommended destination and a second recommended destination to be presented to the occupant of the host vehicle, from the first recommended point and the second recommended point obtained.

2. The information presentation device according to claim 1, wherein the processes further include identifying whether the occupant of the host vehicle is acting in a daily life pattern or a non-daily life pattern, on a basis of a result of determination as to whether the host vehicle is traveling within a preset area, the occupant composition of the host vehicle, a travel point of the host vehicle, and time information, and
identifying an action pattern of the occupant of the host vehicle by referring to, on a basis of a result of the identification as to whether the occupant of the host vehicle is acting in the daily life pattern or the non-daily life pattern, information in which action patterns for the daily life pattern are accumulated or information in which action patterns for the non-daily life pattern are accumulated.

3. The information presentation device according to claim 2, wherein the processes further include referring to information in which an action pattern is accumulated, the accumulated action pattern indicating an action tendency of the occupant of the host vehicle in the non-daily life pattern.

4. The information presentation device according to claim 1, wherein the processes further include determining condition of a driver of the host vehicle, and
when it is determined that the condition of the driver is not suitable for driving, adding a new action pattern to the identified action pattern.

5. The information presentation device according to claim 1, wherein the processes further include determining whether a point at which a driver of the host vehicle has performed a specific driving operation in past is present in a region within a predetermined range from the current location of the host vehicle, by referring to travel histories of the driver, and
when it is determined that the point is present, adding a new action pattern to the identified action pattern.

6. An information presentation system comprising:
a server device including:
a processor to execute a program; and
a memory to store the program which, when executed by the processor, performs processes of,
collecting, from in-vehicle devices mounted on vehicles, pieces of identification information of the vehicles, pieces of information on occupants of the vehicles, and travel histories of the vehicles;
creating vehicle-by-vehicle travel histories, vehicle-by-vehicle action patterns estimated from the vehicle-by-vehicle travel histories, and movement histories, the movement histories being statistical data on the travel histories of the plurality of vehicles;
accumulating the vehicle-by-vehicle travel histories, the action patterns, and the movement histories created;
receiving a request for obtaining information accumulated; and
transmitting the information accumulated in response to the request for obtaining information; and
an information presentation device including:
a processor to execute a program; and
a memory to store the program which, when executed by the processor, performs processes of,
transmitting the request for obtaining information accumulated to the server device;
receiving the information transmitted from the server device;
identifying, on a basis of occupant composition of a host vehicle and time information, an action pattern of an occupant of the host vehicle from action patterns received;
obtaining movement histories and travel histories related to the action pattern identified among movement histories and travel histories received;
extracting movement histories in which the vehicles pass through a reference point and travel histories in which the host vehicle passes through the reference point, among the obtained movement histories and travel histories, the reference point being a current location of the host vehicle or an already set destination;
obtaining a first recommended point on a basis of probabilities of transition indicating probabilities of going to respective points from the reference point in the movement histories extracted;
obtaining a second recommended point on a basis of probabilities of transition indicating probabilities of going to respective points from the reference point in the travel histories extracted; and
determining a first recommended destination and a second recommended destination to be presented to the occupant of the host vehicle, from the first recommended point and the second recommended point obtained.

7. An information presentation method comprising:
identifying, on a basis of at least occupant composition of a host vehicle and time information, an action pattern of an occupant of the host vehicle from information indicating action patterns estimated from past travel histories of the host vehicle;
extracting movement histories in which other vehicles pass through a reference point and travel histories in which the host vehicle passes through the reference point, among movement histories of the other vehicles and travel histories of the host vehicle related to the identified action pattern, the reference point being a current location of the host vehicle or an already set destination;
obtaining a first recommended point on a basis of probabilities of transition indicating probabilities of going to respective points from the reference point in the extracted movement histories, and a second recommended point on a basis of probabilities of transition indicating probabilities of going to respective points from the reference point in the extracted travel histories; and
determining a first recommended destination and a second recommended destination to be presented to the occupant of the host vehicle, from the first recommended point and the second recommended point.
